(19) United States
(12) Patent Application Publication
(10) Pub. No.: US 2016/0183088 A1
(43) Pub. Date: Jun. 23, 2016

(54) Smartphone Memory Diagnostics

(71) Applicant: Ziv Yekutieli, Zichron Yaakov (IL)

(72) Inventor: Ziv Yekutieli, Zichron Yaakov (IL)

(21) Appl. No.: 14/816,091

(22) Filed: Aug. 3, 2015

Related U.S. Application Data
(63) Continuation-in-part of application No. 14/578,364, filed on Dec. 20, 2014, now abandoned.

(51) Int. Cl. H04W 12/06

(52) U.S. Cl. CPC H04W 12/06

(57) ABSTRACT

The invention uses a smartphone activation sequence for administration of a memory task. This may take the form of a pin code (or other N-digit sequence selected from a group of symbols). This code must be entered by the user before being able to use the phone. The symbols are eliminated from the display after a certain initial period, being replaced with placemarks. Thus the user must not only remember the required symbols from time to time, but must also quickly observe and remember the locations of the required symbols, before they are replaced with placemarks.

### CLAIM OF BENEFIT

This application claims benefit of U.S. patent application Ser. No. 14/578364 filed 20 Dec. 2014, being a continuation in part thereof, which itself claims priority from U.S. provisional application No. 61/928028 filed 16 Jan. 2014.

### FIELD OF THE INVENTION

The present invention relates to the field of diagnostic tests administered by means of smartphone.

### BACKGROUND OF THE INVENTION

Diagnostic tests for memory have been administered by a variety of means, in formats ranging from games to formally administered pencil-and-paper tests to computerized means. Generally these tests are administered in bespoke settings such as a doctor's office, classroom, testing facility or the like. As the testing is administered only infrequently and generally in bespoke settings, it will generally be difficult to perform frequent tests able to discern subtle patterns of recall ability over short and long terms.

There is thus a longfelt need for transparent memory testing during everyday activities such as using a smartphone.

### SUMMARY OF THE INVENTION

It is within provision of the invention to use a smartphone activation sequence for administration of a memory task. The task may in one embodiment take the form of a pin code (or other N-digit sequence selected from a group of symbols). This code must be entered by the user before being able to use the phone. A further embodiment involves removing the symbols from being displayed after a certain initial period, instead displaying only a placemark in their stead. Thus the user must not only remember the symbols required (a long-term memory task), he must quickly observe and remember the locations of the required symbols, before they are replaced with placemarks (a short-term memory task). The difficulty of both the long-term and short-term tasks may be individually adjusted, either once, intermittently, or with every use.

The foregoing embodiments of the invention have been described and illustrated in conjunction with systems and methods thereof, which are meant to be merely illustrative, and not limiting. Furthermore just as every particular reference may embody particular methods/systems, yet not require such, ultimately such teaching is meant for all expressions notwithstanding the use of particular embodiments.

### BRIEF DESCRIPTION OF THE DRAWINGS

Embodiments and features of the present invention are described herein in conjunction with the following drawings:

FIG. 1 shows a smartphone screen having a set of numerals that have been placed randomly on the display;

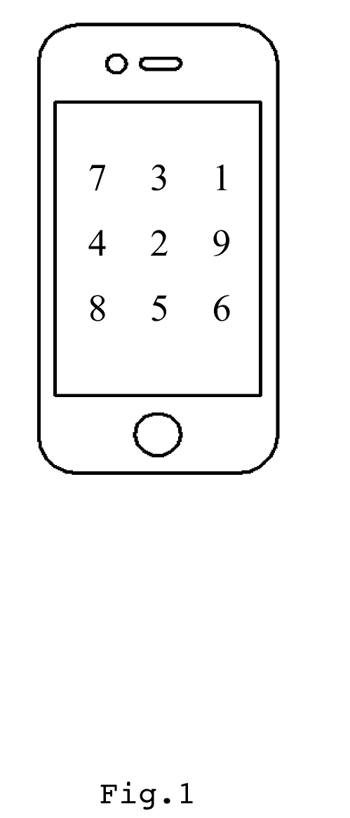

FIG. 2 shows a smartphone screen of FIG. 1 where the numerals have been replaced with placemark symbols.

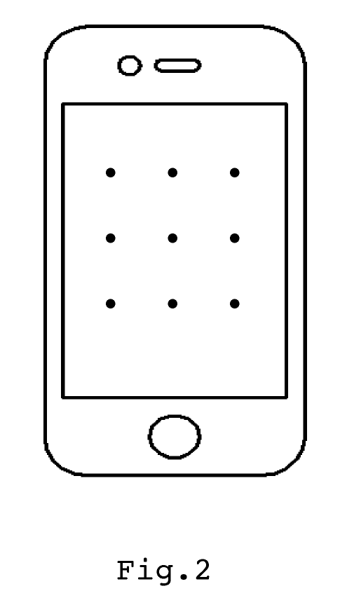

In the figures and/or description herein, the following reference numerals have been utilized throughout the figures:

It should be understood that the drawings are not necessarily drawn to scale.

### DETAILED DESCRIPTION OF PREFERRED EMBODIMENTS

The present invention will be understood from the following detailed description of preferred embodiments, which are meant to be descriptive and not limiting. For the sake of brevity, some well-known features, methods, systems, procedures, components, circuits, and so on, are not described in detail.

The invention uses a smartphone activation sequence for administration of a memory task. In a preferred embodiment, the activation sequence takes the form of a pin code (or other N-digit sequence selected from a group of symbols). This code must be entered by the user, before being able to use the phone.

Thus a long-term memory task must be completed before the user can use the phone. In addition to this long-term task, a short-term memory task is also required. To this end, the numerals or other symbols of the pin code are placed in random positions on the screen, possibly at a set of discrete points such as at the vertices of a matrix. After a certain initial period, or after the first key was pressed, the numerals being displayed are removed and replaced by placemark symbols. Thus the user must not only remember the symbols required from activation to activation, he must quickly observe and remember the locations of the required symbols, before they are replaced with the placemarks (a short-term memory task). The symbols that the user presses do not disappear but remain on the screen. Only those yet to be pressed are not presented.

The difficulty of both the long-term and short-term tasks may be individually adjusted, either once, intermittently, or with every use.

To adjust the difficult of both the long-term and short-term tasks, the length of the required pin may be changed, and/or the number of symbols possible may be changed. To adjust the difficulty of the short-term task independently, the duration in which the symbols are displayed before being replaced by placemarks may be changed.

Furthermore an intermediate-term task may be introduced, by requiring the user to change the pin code every time the phone is unlocked. A new code is entered by appropriate means, and the new code is required the next time the user comes to unlock the phone. This will require memory over durations of minutes to days (the durations between uses of the phone). The short-term requirement is over a period of seconds to minutes (the duration between observing the symbol positions and entering the code). The long-term requirement (if the pin code is not changed between unlocking) is over a period of months to years (the duration during which the user uses the same pin code).

It is within provision of the invention to dictate a fixed timespan for changing pin codes, allowing for administration of fixed intermediate-to long-term memory requirements of the user.

It is within provision of the invention to measure the time the user takes to enter the pin code.

It is within provision of the invention to record the number of mistakes a user makes entering the pin code.

It is within provision of the invention to unlock the phone either after a given number of mistakes are made, and/or after a fixed and unchanging ‘master’ pin code is entered.

It is within provision of the invention to generate analyses of the parameters measured including all those described above (time to enter code, number of mistakes, and the like), both for a given session and historically, for instance analyzing and/or displaying various parameters as they change over time. This analysis may occur locally (on the smartphone) or remotely (for example on a server in communication with the smartphone, to which the various parameters are transmitted).

The foregoing description and illustrations of the embodiments of the invention has been presented for the purposes of illustration. It is not intended to be exhaustive or to limit the invention to the above description in any form.

Any term that has been defined above and used in the claims, should be interpreted according to this definition.

The reference numbers in the claims are not a part of the claims, but rather used for facilitating the reading thereof. These reference numbers should not be interpreted as limiting the claims in any form.

1. A method for smartphone-based administration of a memory task taking the form of a password challenge which must be passed by the user before being able to use said smartphone, consisting of the presentation of a set of symbols to be chosen in order by said user, said symbols being eliminated from the display after a certain initial period and replaced with placemarks, thus requiring the user to remember not only the required order required of symbols, but also to note and remember the locations of the symbols.

2. The method of claim 1 wherein said password challenge requires said user to enter a predetermined N-symbol sequence selected from a group of symbols.

3. The method of claim 1 wherein the password is changed at fixed time intervals and a new password is generated and shown to the user, allowing for administration of fixed intermediate-to long-term memory requirements of the user.

4. The method of claim 1 wherein the password is changed after every use and a new password is generated and shown to the user.

5. The method of claim 1 wherein time the user takes to enter the password is measured.

6. The method of claim 1 wherein the mistakes a user makes entering the password is recorded.
